(19) United States
(12) Patent Application Publication
(10) Pub. No.: US 2025/0190489 A1
(43) Pub. Date: Jun. 12, 2025

(54) USER-SPECIFIC THUMBNAILS

(71) Applicant: DISH Network Technologies India Private Limited, Bangalore (IN)

(72) Inventors: Sagar C. Bellad, Bengaluru (IN); Shishir Pandey, Hyderabad (IN)

(21) Appl. No.: 18/531,569

(22) Filed: Dec. 6, 2023

(51) Int. Cl. G06F 16/738; H04N 21/258

(52) U.S. Cl. CPC G06F 16/738; H04N 21/25891

(57) ABSTRACT

A method of generation and display of thumbnails that correspond to a user-specified genre is disclosed. The method includes accessing, by one or more processing devices, information indicative of a genre of interest associated with a user-profile. The method includes obtaining, by the one or more processing devices, a plurality of frames associated with video content, information about which is to be displayed as a selectable thumbnail within the user-profile, at least one frame that represents characteristics associated with the genre of interest is identified by the one or more processing devices from the plurality of frames. The method includes generating, by the one or more processing devices, a user-profile-specific image from a portion of the at least one frame as the selectable thumbnail corresponding to the video content.

### TECHNICAL FIELD

This specification pertains to generation and display of thumbnails that correspond to a preferred user-identified genre.

### BACKGROUND

Thumbnail images can be a useful visual reference for navigating through video content. Generation of thumbnail images can be processing-intensive and can negatively affect other tasks that require presenting video content to a local user device. Advances in mobile and wireless technologies, have enabled viewers to watch video content on any number of different devices, including computers, mobile phones, tablets, and the like. With video streaming technology, a content delivery network (CDN) or other server allows video content to be processed and pre-stored ahead of delivery and playback. Via the thumbnail images, viewers are able to access streaming content at their local user device.

### SUMMARY

Disclosed herein are technologies related to the generation and display of user-specific thumbnails. Various implementations for generating thumbnail images for video content (i.e., video and audio content) are presented. In some implementations, a thumbnail generation process may be activated and presented on a user device, such as a computer, television, smart phone, or other electronic device capable of receiving and viewing video content.

In one aspect, the technology described herein is embodied in a method that includes accessing, by one or more processing devices, information indicative of a genre of interest associated with a user-profile. The method includes obtaining, by the one or more processing devices, a plurality of frames associated with video content, information about which is to be displayed as a selectable thumbnail within the user-profile. Further, the method includes identifying, by the one or more processing devices from the plurality of frames, at least one frame that represents characteristics associated with the genre of interest. The method proceeds by generating, by the one or more processing devices, a user-profile-specific image from a portion of the at least one frame as the selectable thumbnail corresponding to the video content. In some implementations, the method includes displaying the selectable thumbnail on a display device as a part of a menu associated with the user-profile.

In some implementations, the genre of interest represented in the selectable thumbnail is different from a pre-defined genre-classification of the video content.

In some implementations, the method includes identifying, for at least one frame, a number of times a character has occurred in the plurality of frames.

In some implementations, The method of claim 1, wherein identifying at least one frame identifying, for at least one frame, a facial expression of a character in each of the plurality of frames.

In some implementations, the method includes identifying a brightness of the at least one frame to determine the genre of interest.

In some implementations, in response to identifying the at least one frame, ranking each of the plurality of frames. The method includes selecting, from the plurality of frames, user-profile-specific image from the at least one frame having a highest rank.

In some implementations, the brightness is used to classify the at least one frame as one of a first genre or a second genre different from the first genre.

In some implementations, the method proceeds by determining, in the plurality of frames, a number of interactions between each of one or more main characters among a plurality of characters.

In some implementations, the method includes generating, using two or more facial perspective views, a character database of one or more main characters in the video content, the character database used to classify the character as a main character when a confidence threshold is satisfied.

In some implementations, the method proceeds by accessing, by the one or more processing devices, a genre database that includes data indicative of a first genre and a second genre different from the first genre. The first genre and the second genre have a first value indicative of a first facial expression and second value indicative of a second facial expression. A sum of the first and second values corresponding to the first genre is different than a sum of the first and second values corresponding to the second genre. The method includes utilizing the genre database to generate the selectable thumbnail.

In one aspect, the technology described herein is embodied as one or more non-transitory computer storage media encoded with computer program instructions that when executed by one or more computers cause the one or more computers to perform operations. The operations include accessing, by one or more processing devices, information indicative of a genre of interest associated with a user-profile. The operations include obtaining, by the one or more processing devices, a plurality of frames associated with video content, information about which is to be displayed as a selectable thumbnail within the user-profile; identifying, by the one or more processing devices from the plurality of frames, at least one frame that represents characteristics associated with the genre of interest; and generating, by the one or more processing devices, a user-profile-specific image from a portion of the at least one frame as the selectable thumbnail corresponding to the video content.

In some implementations, the operations include displaying the selectable thumbnail on a display device as a part of a menu associated with the user-profile.

In some implementations, the genre of interest represented in the selectable thumbnail is different from a pre-defined genre-classification of the video content.

In some implementations, the operations include identifying, for at least one frame, a number of times a character has occurred in the plurality of frames.

In some implementations, the operations include identifying, for at least one frame, a facial expression of a character in each of the plurality of frames.

In some implementations, the operations include identifying a brightness of the at least one frame to determine the genre of interest.

In one aspect, the technology described herein is embodied as a system that includes one or more computers and one or more storage devices on which are stored instructions that are operable, when executed by the one or more computers, to cause the one or more computers to perform operations. The operations include accessing, by one or more processing devices, information indicative of a genre of interest associated with a user-profile. The operation further includes obtaining, by the one or more processing devices, a plurality of frames associated with video content, information about which is to be displayed as a selectable thumbnail within the user-profile. The operation proceeds by identifying, by the one or more processing devices from the plurality of frames, at least one frame that represents characteristics associated with the genre of interest. The operations include generating, by the one or more processing devices, a user-profile-specific image from a portion of the at least one frame as the selectable thumbnail corresponding to the video content.

In some implementations, the operations include displaying the selectable thumbnail on a display device as a part of a menu associated with the user-profile, wherein the genre of interest represented in the selectable thumbnail is different from a pre-defined genre-classification of the video content. The operations include identifying, for at least one frame, a number of times a character has occurred in the plurality of frames.

In some implementations, in response to identifying the at least one frame, the operations include ranking each of the plurality of frames. The operations include selecting, from the plurality of frames, user-profile-specific image from the at least one frame having a highest rank.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example of a network environment for providing video content to a user device.

FIG. 2 illustrates an example of details of a thumbnail engine for generating thumbnails within the network environment.

FIG. 3 is a flowchart of an example process for implementing the generation of thumbnails shown in FIGS. 1-5.

FIG. 4 illustrates a character interaction graph of a plurality of characters shown on a frame of video content.

FIG. 5 illustrates a frame of the video content showing unverified character and a pair of characters with similar features.

FIG. 6 illustrates an example of a computing device and a mobile computing device.

Like reference numbers and designations in the various drawings indicate like elements.

### DETAILED DESCRIPTION

The technology described herein pertains to generating user-specific thumbnails for video content in accordance with a user's individual genre preferences. A user may be more likely to select a particular video content if the video content is presented in the menu in accordance with a genre that the user prefers. For example, if a video content-such as a movie or a series—is classified to be primarily of the genre “drama,” a user that prefers the genre “comedy” may be unlikely to select the video content. However, if the same video content is displayed in the menu using a thumbnail that represents a “comedy” scene from the video content, the same user may be more likely to select the content for viewing. This document describes technology that analyzes video content to generate user-specific thumbnails for the video content based on preferred genres of particular users. As such, the same video content may be displayed under different user-profiles using different thumbnails—which in turn may increase the chances of the video content being selected by users as compared to when the video content is displayed using a static thumbnail.

Implementation details of the technology involves individual frames in a plurality of frames in a given media/video content being classified according to a genre. Depending on a user's preference, a thumbnail-generation engine extracts a suitable frame characteristics of which matches the user's preferred genre, and generates a thumbnail from the frame to be displayed as a selectable thumbnail for displaying the video content within a user-profile on a display device of a user device. For the same video content, a first user can be shown a different thumbnail as compared to a second user who has a preferred genre different from the first user.

A network environment can, in some examples, include a streaming platform (e.g., an over-the-top (OTT) service or another media distribution platform/application) that enables creation of a user profile for each individual or subscription on the network. The network environment derives insights about viewer's genre preferences from their viewing habits and stores this information as a user profile in a dataset, such as a database. A user's viewing history, browsing habits, “likes,” and/or “dislikes,” metadata, and the like are collected and stored in the dataset. The dataset can be stored in memory, explained in greater detail below. For example, if a viewer frequently watches comedy content, the streaming platform designates comedy as a preferred genre. As such, the network environment selects a frame within the video content to present as a thumbnail, regardless of how the video content as a whole may be categorized by the service provider or media platform.

In various implementations, the technology described herein can facilitate one or more of the following advantages. The disclosed technology can increase user engagement with the media platform providing the video content by considering the genre preferences of the user and the classification of individual frames without regards to the overall genre of the video content. The technology described herein can increase the amount of time the user spends on the media platform, thus increasing the value of the media platform. By exposing the user to video content that the user would not ordinally be exposed to because it is not classified within the user's preferred genre(s), implementation of this technology can increase user satisfaction with the media platform.

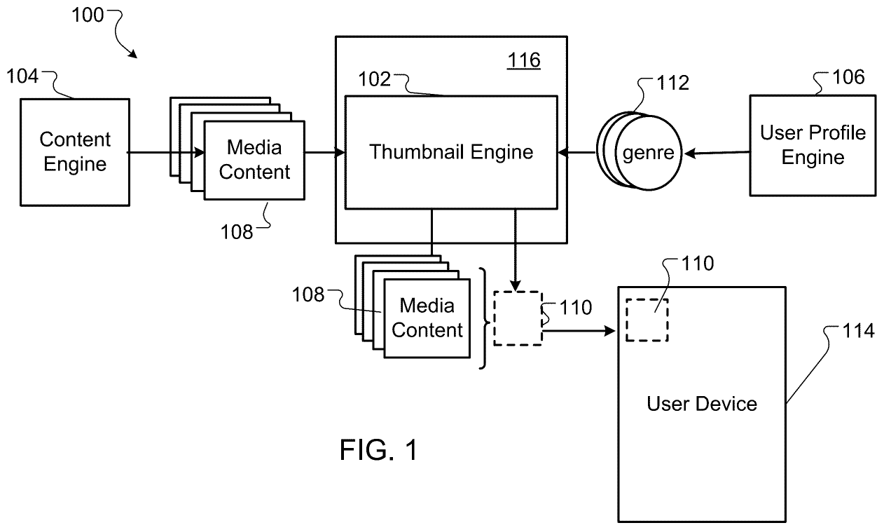

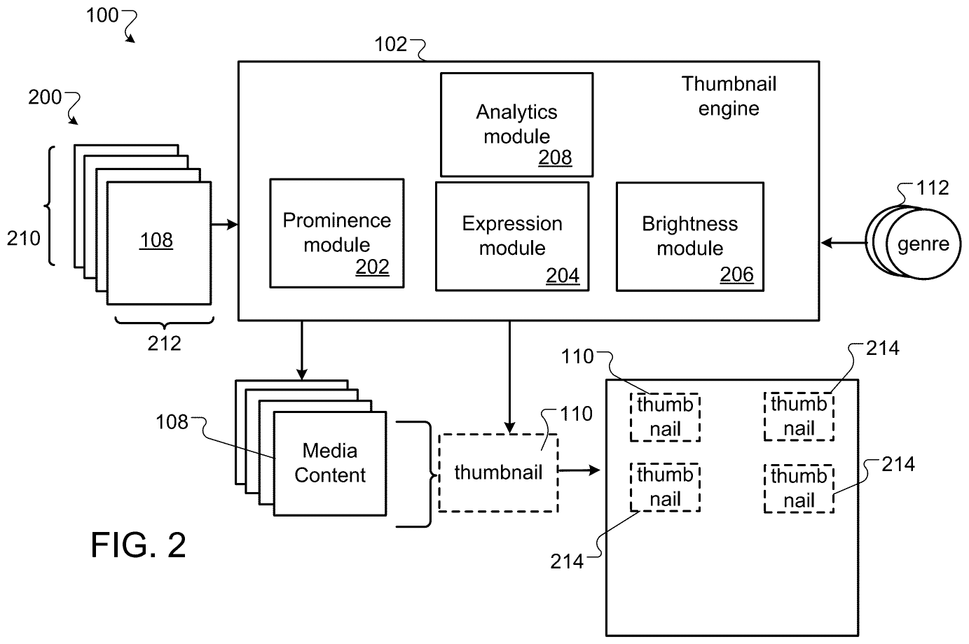

FIG. 1 shows an example of a network environment 100 having a thumbnail engine 102, a streaming content engine 104, and a user profile engine 106 that provide video content 108 to a user device 114. The thumbnail engine 102 receives the video content 108, analyzes the video content 108, and outputs a user preferences 112 to the user device 114 as a result of the analysis occurring in the thumbnail engine 102. In some implementations, the thumbnail engine 102 receives one or more user preferences 112 from the user profile engine 106. In some implementations, the network environment 100 receives video content 108 from one or more servers or a content delivery network (CDN) FIG. 2 shows details of the thumbnail engine 102 in the network environment 100, the thumbnail engine 102 include a prominence module 202, an expression module 204, a brightness module 206, and an analytics module 208. The video content 108 includes a plurality of frames 200 having a height (H) 210 and a width (W) 212. Each of plurality of frames 200 is received by the thumbnail engine 102 and can be analyzed by the prominence module 202, expression module 204, the brightness module 206, and an analytics module 208. One or more user preferences 112 (e.g., a preferred genre) can also be introduced into the thumbnail engine 102 for analysis.

The prominence module 202 executes a function utilizing equation 1 to determine a prominence score,

$${ps}_{i} := ( \frac{{\sum }_{j = 0} pj * Aj}{W * H} ) + ( \frac{{\sum }_{j , k = 0}^{j \neq k} w , jk * ( Aj + Ak )}{W * H} ) .$$

Where pⱼ is the prominence of character j, which is defined by the number of times character j has appeared in all of the frames of the video content divided by the total number of times any main character has appeared through the entirety of the video content. Aj is an area (A) of character j's face within a given frame; wj,k is the number of times character j and k appear together in the plurality of frames; Ak is the area of character k's face within the given frame; W is the width of the frame; and H is the height of the frame. The prominence of character j, is described by:

$${p}_{j} = \frac{n umber of frame appearances of character j}{total number of times any character has appeared} ;$$

and the prominence of characters j and k together is represented by:

$${w}_{j , k} = \frac{n umber of frame appearances of characters j + k}{total number of interactions of two or more characters} .$$

As reflected in equation 1, the prominence score is proportional to the first width and the first height of the plurality of frames. Additionally, the prominence score is proportional to a number of times the character has interacted with a selected one of the main characters, and proportional to an area occupied by a face of the selected one of the main characters.

Equation 2, which is executed by the expression module 204, calculates an expression score. Equation 2 is represented by:

$${ex}_{i} = ( \frac{{\sum }_{j = 0} cj * exj * A j}{T ( g ) * ( W * H )} ) .$$

Cᵢ is a confidence score that indicates a degree of confidence that the thumbnail engine 102 has that the determined expression is an actual expression of character j. A value for a detected expression parameter, exⱼ, is retrieved from a dataset. The confidence score (Cⱼ) is expressed as a probability (e.g., percentage) that the determined expression for the face of a character is an actual expression on the face of the character. As indicated in equation 2, the expression score includes a confidence level (i.e., confidence score) that corresponds to a probability of closely the determined expression of the character matches an actual expression of the character in the given frame.

A total expression score for a given genre, T(g) is represented by a sum of all of the expression associated with the given genre from the dataset. In one implementation, the parameters in the dataset used to calculate the total expression score T(g) are pre-defined for each genre. In another implementation, the parameters in the dataset used to calculate the total expression score T(g) are generated by analyzing expressions of the characters in the video content 108. In yet another implementation, the parameters in the dataset used to calculate the total expression score T(g) are retrieved from metadata in the video content 108 having data that indicates a particular genre. In yet another implementation, the parameters in the dataset are two or more of: pre-defined parameters, parameters generated by analyzing images in the video content 108, and parameters extracted from the metadata of the video content 108. It is understood that the term dataset is used broadly and can be expressed as a database, a look-up table, a list, or other indexed data.

The brightness module 206 can execute a function utilizing equation 3 to determine a brightness score, bsᵢ. The brightness score is a function of the genre, g. In some implementations,

$${b}_{{S}_{i}} = \frac{pixel value}{255} ,$$

where bsᵢ<0.7, else bsᵢ=0, e.g., when the genre is classified as comedy. In another implementation, the brightness score,

$${b}_{{S}_{i}} = 1 - ( \frac{pixel value}{255} ) ,$$

where 1−bsᵢ>0.25, else bsᵢ=0, e.g., when the genre is classified as horror. It is understood that each of the modules 202, 204, 206 can be implemented as either software, hardware, or a combination of both.

The analytics module 208 provides mathematical functions used to produce the thumbnail 110 that are not carried out by one or more of the prominence module 202, expression module 204, the brightness module 206. In some implementations, the analytics module 208 can include software capable of image detection and analysis, calculate the above parameters and probabilities disclosed herein, or a combination of each.

The thumbnail 110 is generated for display to the user device 114, according to the method 300 described below. One or more additional thumbnails 214 can also be generated by the network environment 100 for display to the user device 114.

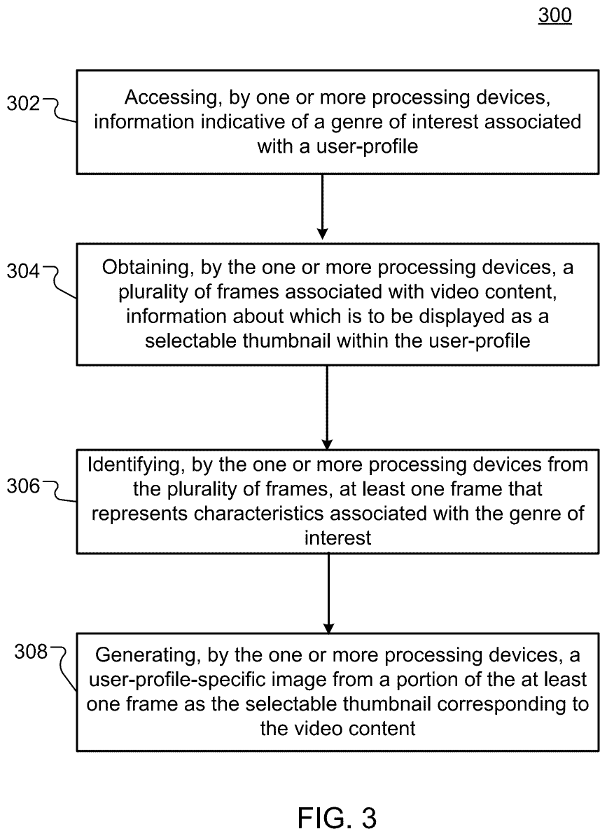

FIG. 3 is a flowchart of an example of a method 300 for implementing the technology described with reference to FIGS. 1-2. The method 300 can begin at operation 302 by accessing, information indicative of a genre of interest associated with a user-profile. The information is accessed via one or more processing devices. The operation includes receiving data indicative of a genre of interest associated with a user profile. For example, the thumbnail engine 102 can receive data from the user profile engine 106 that indicates a preferred genre of a given user (e.g., user preferences 112). The given user, for example, can prefer video content 108 categorized as comedy. In some implementations, the preferred genre can be ranked. For example, comedy can be ranked higher than horror genre, and horror genre may be ranked lower than drama, but higher than romance. Some non-limiting examples of video content include an episode in a streaming or television series, a full-length feature film, a video podcast, or similar video content having one or more recurring characters.

At operation 304, the method 300 includes obtaining, by the one or more processing devices, a plurality of frames associated with video content, information about which is to be displayed as a selectable thumbnail within the user-profile. The thumbnail engine receives video content that includes a plurality of frames. The plurality of frames having a first height and a first width that correspond to an aspect ratio of the video content. Where the video content has more than one aspect ratio, the first height and width are an average height of the plurality of frames. In some implementations, the plurality of frames is a subset of a total number of frames in the video content.

For example, the thumbnail engine 102 can receive video content 108 from the content engine 104. In some implementations, the content engine 104 is a streaming service that provides the video content 108 to the user device 114 without requiring the user device 114 to download and store the video content 108 having the plurality of frames 200. In another implementation, the content engine 104 can be a local or remote storage media that stores the video content 108 and provides the video content 108 through a wired or wireless transfer to the user device 114. The thumbnail engine 102, in some implementations, can be implemented as part of the content engine 104. In another implementation, the video content 108 is implemented as software or hardware configurations on the user device 114.

At operation 306, the method 300 proceeds by identifying, via the one or more processing devices from the plurality of frames, at least one frame that represents characteristics associated with the genre of interest. For each of the plurality of frames, at operation 306, one or more of a prominence score (psᵢ), an expression score (exᵢ), and a brightness score (bsᵢ) is determined. The prominence score (psᵢ) is indicative of a number of times a character has occurred in the plurality of frames. The expression score (exᵢ) is indicative of a facial expression of the character in each of the plurality of frames. The brightness score (bsᵢ) indicatives a brightness of a given frame among the plurality of frames.

The thumbnail engine 102 can utilize other parameters. For example, when identifying a genre (e.g., science fiction), the thumbnail engine 102 can determine an audio score (asᵢ) by determining the volume associated with a given frame 400. In another example, a frame rate change score (frcᵢ) (i.e., a rate at which images between the plurality of frames are changing) is utilized to indicate a genre, such as action or romance. For a drama genre, the thumbnail engine 102 determines drama content, utilizing a scoring system that identifies frames containing the highest number of main characters. For example, the drama expression score (dexᵢ) is number as:

$$d {ex}_{i +} = {ex}_{i} + \frac{n umber of characters identified within a frame}{total number of character appearing in the media content} .$$

An aesthetic score (asᵢ) can also be determined, in some implementations. An aesthetic quality of images in the plurality of frames is determined. For example, colors, contrast, sharpness, resolution, noise, and artifacts can be determined by the thumbnail engine 102 to determine the aesthetic score (asᵢ).

As discussed in further detail below, a frame ranking score (frᵢ) is determined by the thumbnail engine 102. In some implementations, the frame ranking score (frᵢ) is represented by equation 4: frᵢ=psᵢ+exᵢ+bsᵢ. In other implementations, the frame ranking score is represented by equation 5: frᵢ=psᵢ+exᵢ+bsᵢ+frcᵢ+dexᵢ+asᵢ. It is understood that the values of each of the parameters in equation 5 can either be zero or non-zero depending on the genre of interest, the particular frames analyzed, or a combination of both.

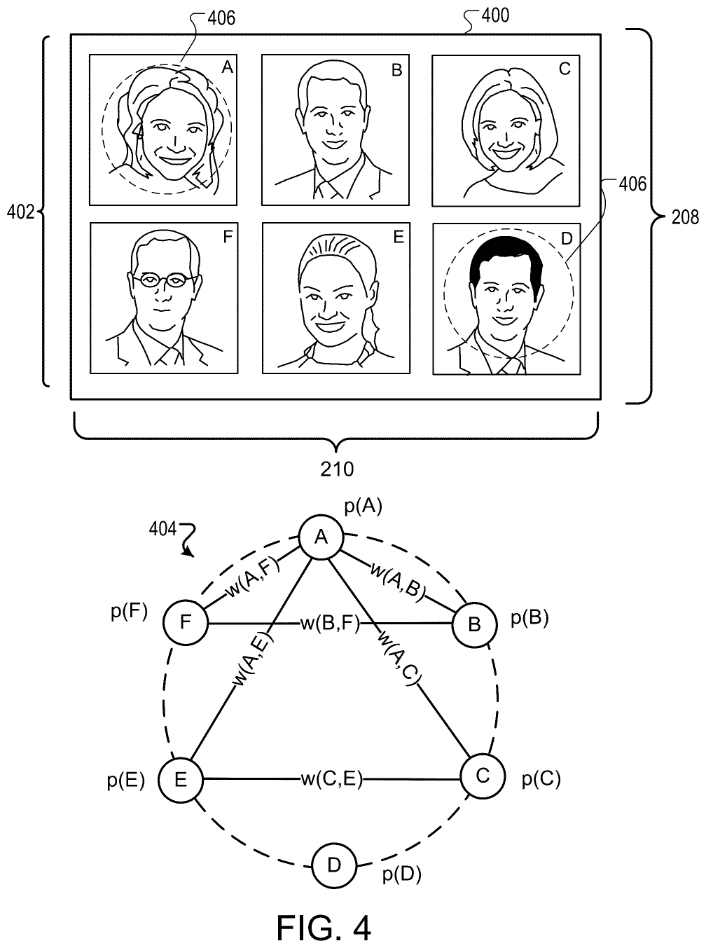

With reference to FIG. 4, a frame 400 is shown, among the plurality frames 200 in the video content 108. The frame 400 shows a plurality of characters 402. A character interaction graph 404 is illustrates an interaction of each of the plurality of characters 402 in each of the plurality of frames 200. In one example, the plurality of characters 402 can be represented by alphanumerically as characters A-F, although it is understood that a fewer or greater number of characters can be represented among the plurality of characters 402. To facilitate discussion, and for purposes of illustrating examples, the characters A-F can be named as follows: A (“Alba”), B (“Brian”), C (“Clara”), D (“David”), E (“Elena”), and F (“Farid”). This specification utilizes the names and alphanumeric values interchangeably throughout the disclosure.

The thumbnail engine 102 can generate a character interaction graph 404 to represent the interactions among characters A-F within the plurality of frames 200. The character interaction graph 404 calculates self-loops, i.e., a frame where a single one of the characters A-F appears alone. The character having the highest self-loop can be designated as a most prominent character.

Image or facial recognition software can be utilized to distinguish between characters A-F. In another example, the characters might be distinguished from one another utilizing metadata in the video content 108. In yet another implementation, metadata and image recognition software may be utilized to distinguish the characters A-F. In some implementations, the thumbnail engine 102 detects foreground and background characters within a given frame. The thumbnail engine 102 excludes frames where the main character is a background character and includes frames where the main character is the foreground of the frame. Accordingly, the efficiency and speed of the image/facial recognition process is increased, since a smaller subset of the frames in the video content is processed via the method 300, described below.

A prominence index (pi) for each character is obtained for characters A-F. An area A of each characters A-F face 406 is obtained for each frame 400 of the plurality of frames 200. For example, Alba might have a prominence index p_{A}=100, because she appeared one hundred times in the plurality of frames 200. While illustrated in FIG. 4 as a circle for simplicity, it is understood that the Area (A) of a character's face 406 can be obtained by image processing techniques, such that the Area A may be represented by other shapes, including non-uniform shapes.

Each character interaction (i.e., appearance in a same frame) between any one character and the remaining characters is determined within the plurality of frames 200. Accordingly, an interaction index (w_{j,k}) indicates the number of times character j interacts with another character, k, where characters j and k are a subset of characters A-F. For example, Alba has an interaction index w for each time Alba appears with another character B-F. The interaction index w_{j,k} increments by 1 for each frame 400 in which j and k appear together.

Turning to FIG. 2 and equation 1, the prominence score is determined using the prominence module 202. The following parameters are inputs to the prominence module 202: the prominence index pi, the interaction index (w_{j,k}) and area A of individual j's face and individual k's face, Aⱼ, Aₖ, and the height (210) and width (212) of the frame 400. In one implementation, the prominence score (psᵢ) is determined for each of the plurality of characters 402. In another implementation, the prominence score (psᵢ) is determined for a subset of the plurality of characters 402, such as one or more ‘main characters.’ The one or more ‘main characters’ can be determined by analyzing information contained in the metadata in the video content 108, the user preferences 112, or a combination of both.

The network environment 100 has access to a dataset that includes portrait views of the main characters. For example, the portrait views of the main characters can include between 3 and 10 perspective views of each of the main characters. In some implementations, the portrait views of the main characters can be between 4 and 8, or between about 5 perspective views, or fewer than 6 perspective views. In some implementations, the portrait views are stored locally in the memory of the one or more computing devices 116. The perspective views (i.e., images) of the main characters can be maintained as a dataset and stored in a character database. The portrait views, in some implementations, differ by about 45 degrees. For example, the portrait views can be at 0°, 45°, 90°, 135°, and 180°. In other implementations, the portrait views differ from one another by between about 350 and about 75°, or between 400 and about 55°.

The thumbnail engine 102 can distinguish main characters from supporting characters by determining the frequency with which a given character occur among the plurality of frames 200. As such, the main characters will satisfy a threshold number of appearances in the plurality of frames 200. Accordingly, the one or more supporting characters occur below the threshold number of times in the plurality of frames 200. In some implementations, such as serial works or episodes, the one or more main characters satisfies a serial threshold number of appearances, which is a number of appearances across multiple series of the video content 108.

The expression module 204 determines the expression score (exᵢ) by utilizing the expression exⱼ of the given character A-F, the area Aⱼ of character j's face 406 within the frame 400, and a total genre score T(g) for a given genre. The height (210) and width (212) of the frame 400, and a confidence level are utilized by the expression module 204 to determine the expression score (exᵢ). A gender diversity score (gdᵢ) can be determined. In one example, the frame 200 identifies frames where couples of opposite-gender appear within the plurality of frames, and the thumbnail engine multiples the expression score (exᵢ) by a factor of 4. Similarly, where frames are identified by couples of the same gender appear, the thumbnail engine multiples the expression score (exᵢ) by 4. For the romantic genre, a “main character” is identified in the video content 108 and receive a higher score than other main characters. Accordingly, the frame having the “main character” is selected by the thumbnail engine 102 for presentation as a thumbnail 110 to the user device 114.

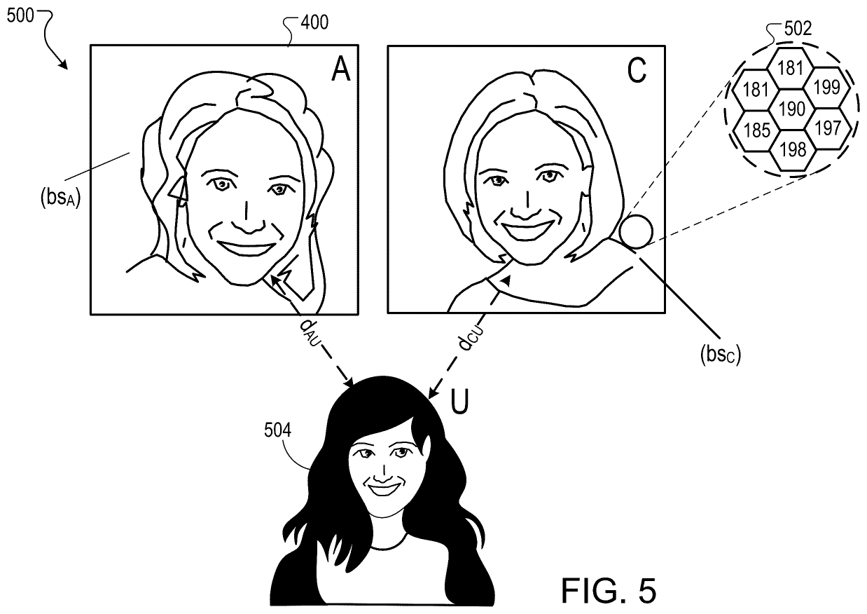

The brightness score (bsᵢ) is determined by the brightness module 206. A brightness score (bsᵢ) is determined for the frame 400. Turning to FIG. 5, in one implementation, a value of each of the pixels 502 of the frame 400 is determined and an average grayscale value of the pixels 502 is used to determine the brightness score (bsᵢ). With reference to equation 3, the user preferences 112 indicated in the user profile engine 106 determines how the brightness score (bsᵢ) is determined, i.e., depending on how the genre is classified, as explained in greater detail above.

In some implementations, each of the expression score (exᵢ) or brightness score (bsᵢ) is determined for a subset of the plurality of characters 402, such as one or more ‘main characters.’ Data utilized to indicate the one or more ‘main characters’ can be determined by analyzing information contained in the metadata in the video content 108 or obtained from information within the user profile engine 106. In some implementations, the brightness score (bsᵢ) can be utilized to distinguish between genres. For example, frames identified as a romantic or comedy genre can have higher brightness scores (bsᵢ) than frames identified as dramatic or horror. In another example, when the preferred genre is specified as comedy, frames having a brightness score, bsᵢ, below a first brightness threshold (i.e., dark frames) are not classified as comedy and therefore can be eliminated from further analysis by the thumbnail engine 102. When the preferred genre is horror, frames having a brightness score bsᵢ above a second brightness threshold are not classified as horror and thus the bright frames can be eliminated from further analysis by the thumbnail engine 102. Thus, increasing computational efficiency of the thumbnail engine 102 and reducing power consumption.

The thumbnail engine 102 classifies a genre utilizing a dataset that gives a score to a set of expressions. For example, in Table 1 infra, a frame 400 can be classified as “Comedy” genre, where a sum of values corresponding to the expressions identified in the video content satisfy a first expression threshold. A frame 400 that is classified as “Romantic,” will satisfy a second expression threshold. A third expression threshold is satisfied for the frame 400 classified as “Horror.” For one or more additional expressions, the thumbnail engine 102 can implement one or more additional expression thresholds. In at least one implementation, Table 1 can be stored in a genre database that stores data indicative of each genre.

Table 1 is an example of part of the dataset that is used to obtain one or more values for the expression parameter, exⱼ. Table 1 includes a list of expression that are associated with or indexed against a given genre. The expression score (exᵢ) includes user-specific data (e.g., the expression parameter, exⱼ) that indicates the user-specific-genre. As explained above, the confidence score(c) is indicative of a level of confidence that the thumbnail engine 102 has in the determined facial expression. When the confidence score (Cⱼ) satisfies a confidence threshold, a value of the identified expression from Table 1 is assigned to the expression parameter, exⱼ. For example, the thumbnail engine 102 determines with a 51% confidence score (cᵢ) that a facial expression is “Happy,” the value 10 is assigned to the expression parameter, exⱼ.

In another example, analytics module 208 detects an expression of the character A in the frame 400. Data is passed to the thumbnail engine 102 to look-up detected expression and retrieve the value from Table 1 associated with the expression. The confidence score cⱼ is determined when the image detection module (number) detects the expression of the character j. As indicated by equation 3, the expression score is proportional to the expression parameter, exⱼ, confidence score cᵢ, and the Area (A) of the character's face 406.

TABLE 1

| Genre 1 | | Genre 2 | | Genre 3 | |
|---|---|---|---|---|---|
| (“COMEDY”) | | (“ROMANTIC”) | | (“HORROR”) | |
| Expression | Value | Expression | Value | Expression | Value |
| HAPPY | 10 | HAPPY | 10 | FEAR | 10 |
| SMILE | 9 | SMILE | 10 | SAD | 10 |
| CALM | 8 | CALM | 10 | CONFUSED | 9 |
| SURPRISED | 4 | SURPRISED | 4 | DISGUSTED | 9 |
| FEAR | 0 | FEAR | 0 | ANGRY | 9 |
| ANGRY | 0 | ANGRY | 0 | SURPRISED | 0 |
| DISGUSTED | 0 | DISGUSTED | 0 | CALM | 0 |
| CONFUSED | 0 | CONFUSED | 0 | SMILE | 0 |
| SAD | 0 | SAD | 0 | HAPPY | 0 |
| TOTAL [G1] | 31 | TOTAL [G2] | 34 | TOTAL [G3] | 47 |

In some implementations, meta data, such as closed caption data, indicates that a particular scene has a mood, and the meta data is used to determine whether one or more of the plurality of frames 200 should be classified as one or more of the genres (1-3) in Table 1. Where the metadata in the plurality of frames 200 is available to the thumbnail engine 102, the metadata can identify a mood of one or more frames 400 in the plurality of frames 200. Where the metadata is utilized, the method 300 can skip the frames that have been classified with a particular mood, at operation 306. For example, if the user prefers comedy, but the mood of the frame 400 is identified as dramatic, the thumbnail engine 102 can skip the frame identified as comedy, thus eliminating the associated analytics of the prominence score (psᵢ), the expression score (exᵢ), and the brightness score (bsᵢ). When one or more frames 400 are skipped, the thumbnail engine 102 does not calculate values for the frames 400 of main characters or secondary characters, thus increasing computational efficiency of the thumbnail engine 102.

The thumbnail engine 102, in some implementations, utilizes a non-random sample of the plurality of frames 200 to determine which frame 400 should be presented as the thumbnail 110. For example, once the A-F have been identified, the thumbnail engine 102 can limit the method 300 to the plurality of frames 200 that include a main character. Thus, by limiting the method 300 to main characters, the method 300 achieves computational efficiency, reduced power consumption, and can determine which frame 400 to present as the thumbnail 110 with greater speed.

In some implementations, the values in Table 1 are derived. For example, where a video content is pre-defined to a specific genre, e.g., a horror genre, expressions identified in x number of frames 400 would be analyzed and bins created for y number of identified expressions. For example, out of 1000 frames 400, 550 frames could have a facial expression determined by as fearful, and 100 frames could have a face characterized as angry. Accordingly, the facial expressions indicating a fearful expression would have a value in Table 1 that is higher than a value associated with the angry expression. In this implementation, each expression determined by the thumbnail engine 102 is given a value (normalized) in relation to the other values (i.e., a normalized value) and the results are stored in Table 1 and indexed against the determined expression.

Returning to FIG. 5, the method 300 can include additional analysis where two or more characters 500 have similar features, e.g., two or more of characters A-F. A similarity score (ssᵢⱼ) is calculated for each pair of characters and a distance (dᵢⱼ) is determined between the two given faces 406 among the two or more characters 500. The distance (dᵢⱼ) and similarity score (ssᵢⱼ) are stored in the database. If there are no main characters identified in a given frame, the thumbnail engine 102 does not index the given frame for selection. Advantageously, computational efficiency is achieved and the method 300 is implemented in less time because fewer frames are processed by the entirety of the method 300.

When the similarity score (ssᵢⱼ) between two characters satisfies a similarity threshold, the method 300 proceeds with the additional analysis. For example, if the analytics module 208 have determined the similarity score (ssᵢⱼ) for Alba and Clara to satisfy the similarity threshold, additional verification by the analytics module 208 is required when either Alba or Clara are detected in a frame 400. For example, an unverified character U is identified by the analytics module 208 that could be either Alba or Clara.

A distance (d_{AU}) is determined between Alba's face 406 and the unverified face 504 of the unverified person U. In addition, a distance (d_{CU}) between the unverified face 504 of the unverified person U and Clara's face 406 is determined. Only where the distance (d_{CU}) between the unverified face 504 and Clara's face 406 is higher than a distance (d_{AU}) between the unverified face 504 and Alba's face 406, is the unverified face 504 classified as Alba. Stated differently, the distance (d_{AU}) between Alba's face 406 and the unverified face 504 is less than the distance (d_{CU}) between Clara's face 406 and the unverified face 504. In some implementations, the analytics module 208 can compare specific points or vectors on the faces of the characters when determining the distance (dᵢⱼ).

At operation 308, the method includes generating, by the one or more processing devices, a user-profile-specific image from a portion of the at least one frame as the selectable thumbnail corresponding to the video content. The method 300 includes displaying the thumbnail on a display device as a part of a menu associated with the user-profile. The user-profile specifies that the genre represented in the selectable thumbnail is different from a pre-defined genre-classification of the video content. The method 300 includes determining a plurality of frame ranking scores (frᵢ). The frame ranking score is the sum of the prominence score (psᵢ), an expression score (exᵢ), and a brightness score (bsᵢ), represented by equation 4: frᵢ=psᵢ+exᵢ+bsᵢ. Unless frames have been excluded from analysis as explained above, each frame 400 receives a frame ranking score (frᵢ), such that there are n number of frame ranking scores (frᵢ) for n number of frames 400 for a total of n² frame ranking scores (frᵢ).

The method 300 can proceed by selecting, among the plurality of frames, a presentation frame having a highest frame ranking score (frᵢ). For example, in some implementations the analytics module 208 generate a dataset, such as a table or database in which a given frame 200 is indexed and paired with a frame ranking score frᵢ.

The method 300 can proceed by generating a thumbnail of the presentation frame for presentation to a user device. The thumbnail has a width and a height that are less than the first width and first height of the plurality of frames. The thumbnail indicates the genre of interest and as specified in the user profile. The thumbnail is coupled to an executable function that initiates or launches the video content on the user device. In some implementations, the user device 114 displays the thumbnail 110 generated by the method 300 described herein. In another implementation, one or more additional thumbnails 214 are generated for display to the user device 114 that indicate a different genre than the thumbnail 110.

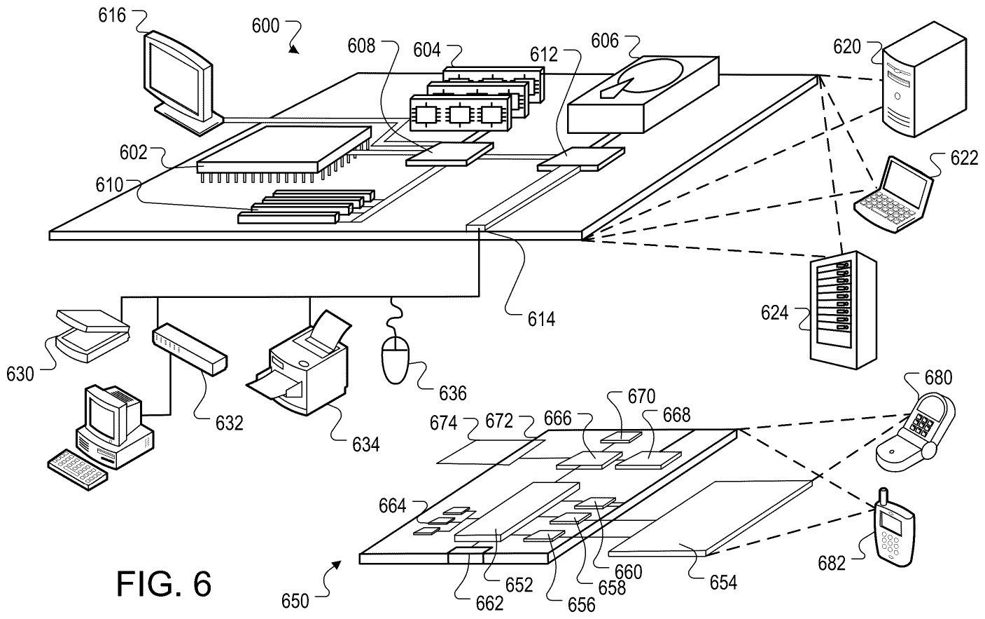

FIG. 6 shows an example of a computing device 600 and a mobile computing device 650 that are employed to execute implementations of the present disclosure. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 600 and/or the mobile computing device 650 can form at least a portion of the network environments (e.g., network environment 100) described above. The computing device 600 and/or the mobile computing device 650 can also form at least a portion of the one or more computing devices 116 or user device 114 described above. In some implementations, the network functions and/or network entities described above can be implemented using a cloud infrastructure including multiple computing devices 600 and/or mobile computing devices 650.

The computing device 600 includes a processor 602, a memory 604, a storage device 606, a high-speed interface 608, and a low-speed interface 612. In some implementations, the high-speed interface 608 connects to the memory 604 and multiple high-speed expansion ports 610. In some implementations, the low-speed interface 612 connects to a low-speed expansion port 614 and the memory 604 (i.e., a storage device). Each of the processor 602, the memory 604, the storage device 606, the high-speed interface 608, the high-speed expansion ports 610, and the low-speed interface 612, are interconnected using various buses, and may be mounted on a common motherboard or in other manners as appropriate. The processor 602 can process instructions for execution within the computing device 600, including instructions stored in the memory 604 and/or on the storage device 606 to display graphical information for a graphical user interface (GUI) on an external input/output device, such as a display 616 coupled to the high-speed interface 608. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system). The low-speed expansion port 614 can be electrically and physically coupled to a mouse 636, a printer 634, a personal computer 632, a scanner 630, or similar devices.

The memory 604 stores information within the computing device 600. In some implementations, the memory 604 is a volatile memory unit or units. In some implementations, the memory 604 is a non-volatile memory unit or units. The memory 604 may also be another form of a computer-readable medium, such as a magnetic or optical disk.

The storage device 606 can provide mass storage for the computing device 600. In some implementations, the storage device 606 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 602, perform one or more methods, such as those described above. The instructions can also be stored by one or more storage devices, such as computer-readable or machine-readable mediums, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards. In the implementation, the low-speed interface 612 is coupled to the storage device 606 and the low-speed expansion port 614. The low-speed expansion port 614, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 614 through a network adapter. Such network input/output devices may include, for example, a switch or router.

The computing device 600 may administered in a number of different forms, as shown in the FIG. 6. For example, it may be implemented as a standard server 620, or multiple times in a group of such servers. In addition, it may be implemented in a personal computer such as a laptop computer 622. It may also be used as part of a rack server system 624. Alternatively, components from the computing device 600 may be combined with other components in a mobile device, such as a mobile computing device 650. Each of such devices may contain one or more of the computing device 600 and the mobile computing device 650, and an entire system may be made up of multiple computing devices communicating with each other.

The mobile computing device 650 includes a processor 652; a memory 664; an input/output device, such as a display 654; a communication interface 466; and a transceiver 668; among other components. The mobile computing device 650 may also be provided with a storage device, such as a micro-drive or other device, to provide additional storage. Each of the processor 652, the memory 664, the display 654, the communication interface 666, and the transceiver 668 are inter-connected using various buses, and several of the components may be mounted on a common motherboard or in other manners as appropriate. In some implementations, the mobile computing device 650 may include a camera device(s).

The processor 652 can execute instructions within the mobile computing device 650, including instructions stored in the memory 664. The processor 652 may be implemented as a chipset of chips that include separate and multiple analog and digital processors. For example, the processor 652 may be a Complex Instruction Set Computers (CISC) processor, a Reduced Instruction Set Computer (RISC) processor, or a Minimal Instruction Set Computer (MISC) processor. The processor 652 may provide, for example, for coordination of the other components of the mobile computing device 650, such as control of user interfaces (Uis), applications run by the mobile computing device 650, and/or wireless communication by the mobile computing device 650.

The processor 652 may communicate with a user through a control interface 658 and a display interface 656 coupled to the display 654. The display 654 may be, for example, a Thin-Film-Transistor Liquid Crystal Display (TFT) display, an Organic Light Emitting Diode (OLED) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may provide communication with the processor 652, to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a Single in Line Memory Module (SIMM) card interface. The expansion memory 674 may provide extra storage space for the mobile computing device 650 or may also store applications or other information for the mobile computing device 650. Specifically, the expansion memory 674 may include instructions to carry out or supplement the processes described above and may include secure information also. Thus, for example, the expansion memory 674 may be provided as a security module for the mobile computing device 650 and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 652, perform one or more methods, such as those described above. The instructions can also be stored by one or more storage devices, such as one or more computer-readable or machine-readable mediums, such as the memory 664, the expansion memory 674, or memory on the processor 652. In some implementations, the instructions can be received in a propagated signal, such as, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS), IP Multimedia Subsystem (IMS) technologies, and 5G technologies. Such communication may occur, for example, through the transceiver 668 using a radio frequency. In addition, short-range communication, such as using a Bluetooth or Wi-Fi, may occur. In addition, a Global Positioning System (GPS) receiver module 670 may provide additional navigation- and location-related wireless data to the mobile computing device 650, which can be appropriately used by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in FIG. 6. For example, it may be implemented in the UE (e.g., one or more computing devices 116 or user device 114) described with respect to FIG. 1. Other implementations may include a phone device 680, a personal digital assistant 682, and a tablet device (not shown). The mobile computing device 650 may also be implemented as a component of a smart-phone, AR device, or other similar mobile device.

The computing device 600 may be implemented in the network environment 100 described above with respect to FIGS. 1-5. Computing device 600 and/or 650 can also include USB flash drives. The USB flash drives may store operating systems and other applications. The USB flash drives can include input/output components, such as a wireless transmitter or USB connector that may be inserted into a USB port of another computing device.

Disclosed herein are systems and methods for generating and displaying user-specific thumbnail. Other embodiments and applications not specifically described herein are also within the scope of the following claims. Elements of different implementations described herein may be combined to form other embodiments.

What is claimed is:

1. A method comprising:
accessing, by one or more processing devices, information indicative of a genre of interest associated with a user-profile;
obtaining, by the one or more processing devices, a plurality of frames associated with video content, information about which is to be displayed as a selectable thumbnail within the user-profile;
identifying, by the one or more processing devices from the plurality of frames, at least one frame that represents characteristics associated with the genre of interest; and
generating, by the one or more processing devices, a user-profile-specific image from a portion of the at least one frame as the selectable thumbnail corresponding to the video content.

2. The method of claim 1, comprising:
displaying the selectable thumbnail on a display device as a part of a menu associated with the user-profile.

3. The method of claim 1, wherein the genre of interest represented in the selectable thumbnail is different from a pre-defined genre-classification of the video content.

4. The method of claim 1, wherein identifying at least one frame comprises:
identifying, for at least one frame, a number of times a character has occurred in the plurality of frames.

5. The method of claim 1, wherein identifying at least one frame comprises:
identifying, for at least one frame, a facial expression of a character in each of the plurality of frames.

6. The method of claim 1, comprising:
identifying a brightness of the at least one frame to determine the genre of interest.

7. The method of claim 1, comprising:
in response to identifying the at least one frame, ranking each of the plurality of frames; and
selecting, from the plurality of frames, user-profile-specific image from the at least one frame having a highest rank.

8. The method of claim 6, wherein:
the brightness is used to classify the at least one frame as one of a first genre or a second genre different from the first genre.

9. The method of claim 7, further comprising:
determining, in the plurality of frames, a number of interactions between each of one or more main characters among a plurality of characters.

10. The method of claim 7, comprising:
generating, using two or more facial perspective views, a character database of one or more main characters in the video content, the character database used to classify the character as a main character when a confidence threshold is satisfied.

11. The method of claim 1, comprising:
accessing, by the one or more processing devices, a genre database comprising data indicative of a first genre and a second genre different from the first genre, wherein the first genre and the second genre comprise:
a first value indicative of a first facial expression and second value indicative of a second facial expression; and
a sum of the first and second values corresponding to the first genre is different than a sum of the first and second values corresponding to the second genre; and
utilizing the genre database to generate the selectable thumbnail.

12. One or more non-transitory computer storage media encoded with computer program instructions that when executed by one or more computers cause the one or more computers to perform operations comprising:
accessing, by one or more processing devices, information indicative of a genre of interest associated with a user-profile;
obtaining, by the one or more processing devices, a plurality of frames associated with video content, information about which is to be displayed as a selectable thumbnail within the user-profile;
identifying, by the one or more processing devices from the plurality of frames, at least one frame that represents characteristics associated with the genre of interest; and
generating, by the one or more processing devices, a user-profile-specific image from a portion of the at least one frame as the selectable thumbnail corresponding to the video content.

13. The method of claim 12, comprising:
displaying the selectable thumbnail on a display device as a part of a menu associated with the user-profile.

14. The method of claim 12, wherein the genre of interest represented in the selectable thumbnail is different from a pre-defined genre-classification of the video content.

15. The method of claim 12, wherein identifying at least one frame comprises:
identifying, for at least one frame, a number of times a character has occurred in the plurality of frames.

16. The method of claim 12, wherein identifying at least one frame comprises:
identifying, for at least one frame, a facial expression of a character in each of the plurality of frames.

17. The method of claim 12, comprising:
identifying a brightness of the at least one frame to determine the genre of interest.

18. A system comprising:
one or more computers and one or more storage devices on which are stored instructions that are operable, when executed by the one or more computers, to cause the one or more computers to perform operations comprising:
accessing, by one or more processing devices, information indicative of a genre of interest associated with a user-profile;
obtaining, by the one or more processing devices, a plurality of frames associated with video content, information about which is to be displayed as a selectable thumbnail within the user-profile;
identifying, by the one or more processing devices from the plurality of frames, at least one frame that represents characteristics associated with the genre of interest; and
generating, by the one or more processing devices, a user-profile-specific image from a portion of the at least one frame as the selectable thumbnail corresponding to the video content.

19. The method of claim 18, comprising:
displaying the selectable thumbnail on a display device as a part of a menu associated with the user-profile, wherein the genre of interest represented in the selectable thumbnail is different from a pre-defined genre-classification of the video content; and
identifying, for at least one frame, a number of times a character has occurred in the plurality of frames.

20. The method of claim 18, comprising:
in response to identifying the at least one frame, ranking each of the plurality of frames; and
selecting, from the plurality of frames, user-profile-specific image from the at least one frame having a highest rank.
